(19) United States
(12) Patent Application Publication
(10) Pub. No.: US 2013/0139758 A1
(43) Pub. Date: Jun. 6, 2013

(54) POULTRY FEEDING DEVICE

(71) Applicant: Frederick W. Steudler, JR., Conestoga, PA (US)

(72) Inventor: Frederick W. Steudler, JR., Conestoga, PA (US)

(21) Appl. No.: 13/309,992

(22) Filed: Dec. 2, 2011

(51) Int. Cl. A01K 39/01; A01K 39/00

(52) U.S. Cl. 119/53; 119/61.3; 119/57.92

(57) ABSTRACT

A poultry feeder is provided that may be fully charged with feed. In one embodiment, the feeder includes a feeder tower and a feeder pan assembly that is vertically moveable with respect to the pan. The feeder pan assembly is movable between a first closed position in which a bottom end of the feeder tower engages the feeder pan and a second open position forming a gap between the end of the tower and pan to dispense feed. Feed is precluded from entering the pan when the feeder pan assembly is in the first position. In one embodiment, the feeder pan assembly is operated between the two positions via a cable. An adjusting collar may be provided to regulate the amount of feed dispensed to the feeder pan.

### FIELD OF THE INVENTION

The invention generally relates to the field of feeder systems used for feeding poultry, and more specifically poultry feeders that dispense feed to birds.

### BACKGROUND OF THE INVENTION

A typical poultry house is long structure that may have a length of several hundred feet, a width of about 40-60 feet, and may house about 15,000-20,000 birds. Poultry houses are often equipped with an automated feeding system consisting of one or more feed delivery lines which run the length of the poultry house.

Poultry feedings systems of the pan-type are well-known in the art. Examples of such feeding systems and feeders used in them are disclosed in U.S. Pat. Nos. 6,655,317; 5,007,380; 4,476,811; 4,003,339; 3,971,340; 3,598,087; 3,415,228; 3,230,933; and 3,033,163; which are incorporated herein by reference in their entireties. As generally disclosed in these various patents, feed from an bulk feed storage tank located outside of the poultry house is conveyed and discharged into one or more feed hoppers or similar distributed receptacles that may be located inside the house.

An example of conventional pan-type feeding systems are shown in FIGS. 1A and 1B. Such poultry feeding systems generally include one or more indoor feed supply hoppers A fluidly coupled to a feed conveyor tube B communicating with the bottom of each hopper. A main feed supply pipe Q fluidly connects the outdoor bulk feed storage tank (not shown) to the one or more feed supply hoppers A and their respective feed conveyor tubes B. The supply hoppers A may be fluidly connected to the main feed supply pipe Q with expansion joints R that allow the supply hoppers A to be raised or lowered with respect to the stationary supply pipe Q which is fixedly hung from the poultry house structure.

In known fashion, within the feed conveyor tube B is a helical conveyor or auger driven by motor C that conveys the granular feed from the hopper A into the plurality of poultry feeders D. Each of the poultry feeders D has a feed bowl or pan E into which the feed passes from feed conveyor tube B through a feed drop tube or feeder tower H, and a protective grill F that enables the birds to obtain feed from the feeder pan, but prevents the birds from entering the feeder pan (see also FIGS. 2A and 2B showing a feeder D and feeder tower H, respectively).

As shown in FIGS. 2A and 2B, the generally tubular feeder tower H may contain windows or openings L through which feed is delivered to the feed pan E and a plurality of fins M to minimize the likelihood of birds from scratching feed out of the pan. The feeder towers H generally include provisions on top for supporting an anti-roost wire K that extends longitudinally along and above feed conveyor tube B as shown in FIG. 1.

It is also known to support the poultry feeders D by attaching the feeder tower H of the feeders to the conveyor tube B as shown in FIG. 1 via an opening J formed in a feeder tower cap I affixed to the top of the feeder tower (see also FIGS. 2A and 2B). Openings in the feed conveyor tube B communicate with a feed inlet in the tower cap I that delivers feed to the feeder pan D below via gravity.

When the birds are very young, the poultry feeders D may be located on, or adjacent to the floor (not shown below the feeders). As the birds mature and grow, the entire feeding system is raised above floor level to enable the birds to readily access and obtain feed from the feeder pans. Typically, a motorized (or alternatively manual) winch system is provided comprising a motorized winch N and a series of pulleys O and support wires G attached to the feed conveyor tube B that are used to support the poultry feeders D. The entire conveyor tube/poultry feeder assembly B, D is raised or lowered in unison as a single unit to a using the winch system to the desired level needed to effectively feed the birds.

For broiler breeders, it is desirable to carefully ration the amount of feed that the birds receive to allow for a more moderate growth rate than broilers. As an example, breeders may be generally fed approximately 110-170 grams of feed daily in contrast to broilers which are fed larger amounts of feed to attain grow-out size more quickly. Accordingly, there is a further need to provide the ability to regulate the amount of feed charged in the feeder D in a controlled manner.

Referring to FIGS. 2A and 2B, the relative positions between the bottom outlet of the feeder tower H and the feed pan E may be manually adjusted via adjustment ring mechanisms P (often marked with indicia Q for setting repeatability) in some of the foregoing known feeders D. This restricts and regulates the amount of feed that may enter and fill the pan to obtain a predetermined desired level of feed in the pan during the pan filling operation of the feed system. Although such feeder systems may regulate the amount of feed provided to the birds, these known system generally do not provide a means for fully closing or shutting off the feeders D and preventing the delivery of feed from the feeder tower H into the feed pan E. Because these prior known feeders D are generally always in an “open” or “on” condition such that when feed is delivered to the feeders via feed conveyor tube B during the feeder fill or charging operation, the feed is immediately dispensed from the feeder tower H into the feed pan E in real time to the awaiting birds. Therefore, these known feed systems generally lack the ability to keep the feed conveyor tube B network and feeders D fully charged immediately prior to the intended feeding time, which is important for ensuring that an accurate amount of feed is dispensed to the birds and that all feeders D are uniformly filled with the same amount of feed and available at the same time.

In addition, if feed equipment malfunctions occur during the instantaneous type feeder charging and feed dispensing operation with such known feed systems, there is little or no time to take corrective action to remedy the equipment problems. The feeders may be only partially charged or not charged at all with feed. Consequently, the birds may not receive feed at the intended time.

An improved poultry feed system is desired that allows the system and individual poultry feeder units to be fully filled or charged with feed in advance of allowing birds access to the feed.

### SUMMARY OF THE INVENTION

The present invention provides poultry feed system having a plurality of feeders that advantageously may be fully charged with feed while precluding feed from entering the feeder pan until the desired feeding time. The individual feeder units may therefore be pre-charged and immediately ready to dispense a full and measured ration of feed to the birds in a controlled manner. Advantageously, the risk of overfeeding is minimized or eliminated.

To enable a fully charged feed system to be maintained, a poultry feeder according to embodiments of the present invention provides a mechanism for completely shutting off the flow of feed into the feeder pan at each feeder. This allows the system and individual feeders to be fully charged with feed, but at the same time precludes feed from flowing into the feeder pan until the desired feeding time. In one embodiment, the shutoff mechanism is achieved by a feeder pan assembly that is axially moveable relative to the feeder tower from an open position in which the feeder pan is disengaged from the feeder tower, to a closed position in which the feeder pan is engaged with the feeder tower. In the closed position, the bottom of the feeder tower engages the feeder pan to prevent outflow of feed from a fully charged tower into the pan. In the open position, the feeder tower is vertically raised above the feeder pan so that the bottom of the tower disengages the feeder pan forming an annular shaped feed opening or orifice so that feed may flow from the charged tower via gravity into the pan.

In additional embodiments of the present invention, a poultry feeder includes an adjustment mechanism that provides user-variable adjustment of the relative positions between the open bottom of the feeder tower and the feeder pan. This controls the size of the feed opening or gap between the feeder tower and feeder pan, and correspondingly regulates the amount of feed entering the pan when the feeder tower is moved to the raised open/dispensing position. In one embodiment, the adjustment mechanism is achieved by a rotatable adjusting collar that allows a user to selectively preset the gap between the feeder tower and feeder pan when the feeder tower is in the fully open position.

In one embodiment, a poultry feeder includes a feeder pan assembly including a feeder pan, a grill assembly mounted on the feeder pan, and an adjusting collar supported by the grill assembly, and further includes a feeder tower including an upper portion for receiving feed and a lower portion having an open bottom end for dispensing feed into the feeder pan. The feeder pan assembly is axially moveable as a unit relative to the feeder tower from an open position in which the feeder pan is disengaged from the feeder tower, to a closed position in which the feeder pan is engaged with the feeder tower. The feeder is operable to preclude feed from entering the feeder pan from the feeder tower when the feeder pan assembly is in the closed position and operable to dispense feed from the feeder tower into the feeder pan when the feeder pan assembly is in the open position.

In one embodiment, the bottom end of the feeder tower engages the feeder pan in the closed position and the bottom end of the feeder tower is spaced apart from the feeder pan by a gap in the open position. In some embodiments, the feeder pan assembly is raised upwards with respect to the feeder tower when moving from the open position to the closed position such that the open position is a lower vertical position and the closed position is an upper or higher vertical position of the feeder pan assembly.

The feeder may further include an operating cable attached to the feeder pan assembly, wherein the cable is coupled to a lifting mechanism such as without limitation a winch that is operable to raise the feeder pan assembly from a lower open position to an upper closed position. In one embodiment, the operating cable may be connected to an anti-roost wire which is coupled to the lifting mechanism; the anti-roost wire being axially moveable in a horizontal direction via operating the lifting mechanism such that moving the anti-roost wire in opposing axial directions raises or lowers the feeder pan assembly with respect to the feeder tower. The feeder tower may remain stationary during movement of the feeder pan assembly.

A method for operating a poultry feeder is also provided. In one embodiment, the method includes: providing a poultry feeder comprising a feeder pan, a grill assembly, an adjusting collar, and a feeder tower configured for receiving and dispensing feed to the feeder pan, wherein the feeder pan, grill assembly, and adjusting collar collectively define an interconnected feeder pan assembly being independently movable from the feeder tower; positioning the feeder pan at an elevated position above the floor of a poultry house; engaging an open bottom end of the feeder tower with the feeder pan, the feeder pan assembly being in a first raised closed position; filling the feeder tower with feed, wherein feed is prevented from flowing into the feeder pan by the engagement between the bottom end of feeder tower and the pan; lowering the feeder pan assembly to a second lowered open position; and disengaging the bottom end of the feeder tower from the feeder pan to form a gap therebetween, wherein feed flows into the feeder pan from the feeder tower. In one embodiment, an operating cable may be attached to the feeder pan assembly that is operable to lower the feeder pan assembly to the second lowered open position.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIGS. 1A and 1B each show a conventional pan-type poultry feeding system with feeder supply hoppers, conveyor feed tubing, and poultry feeders;

FIG. 2A is a perspective view of a conventional poultry feeder;

FIG. 2B is a perspective view of the feeder tower shown in FIG. 2A;

FIG. 3 is a perspective view of a feeder tower according to one embodiment of the present invention;

FIG. 4 is a cross-sectional side elevation view thereof;

FIG. 5 is a cross-sectional side elevation view of a poultry feeder according to one embodiment of the present invention;

FIG. 6 is a cross-sectional side elevation view thereof rotated 90 degrees from FIG. 5 and showing the feeder tower in a fully closed shutoff position;

FIG. 7 is a cross-sectional side elevation view thereof showing the feeder tower in a fully open dispensing position;

FIG. 8 is a perspective view of a poultry feeder system including a moveable feeder pan assembly according to one embodiment of the invention;

FIG. 9 is a close-up perspective view of the poultry feeder shown in FIG. 8;

FIG. 10 is a cross-sectional side elevation view thereof showing the feeder pan assembly in a fully closed shutoff position;

FIG. 11 is a cross-sectional side elevation view thereof showing the feeder pan assembly in a fully open dispensing position;

FIG. 12 is a side view of the poultry feed system of FIG. 8 showing one embodiment of a winch with internals visible in greater detail;

FIG. 13 is a top view thereof; and

FIG. 14 is an alternative embodiment of the feeder tower of FIG. 4 having fins M as in FIG. 2B.

### DETAILED DESCRIPTION OF THE PREFERRED EMBODIMENTS

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively or operably connected” is such an attachment, coupling or connection that allows the pertinent structures to operate as intended by virtue of that relationship. When only a single machine is illustrated, the term “machine” shall also be taken to include any collection of machines that individually or jointly execute a set (or multiple sets) of instructions to perform any one or more of the methodologies discussed herein. In the claims, means-plus-function clauses, if used, are intended to cover the structures described, suggested, or rendered obvious by the written description or drawings for performing the recited function, including not only structural equivalents but also equivalent structures.

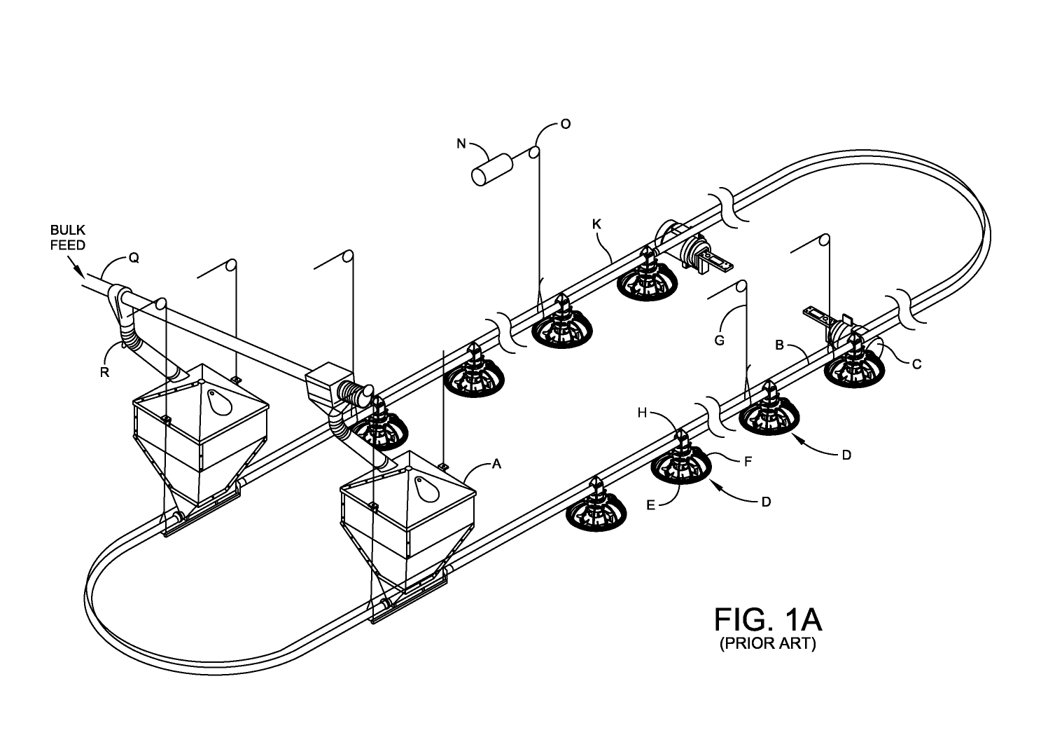

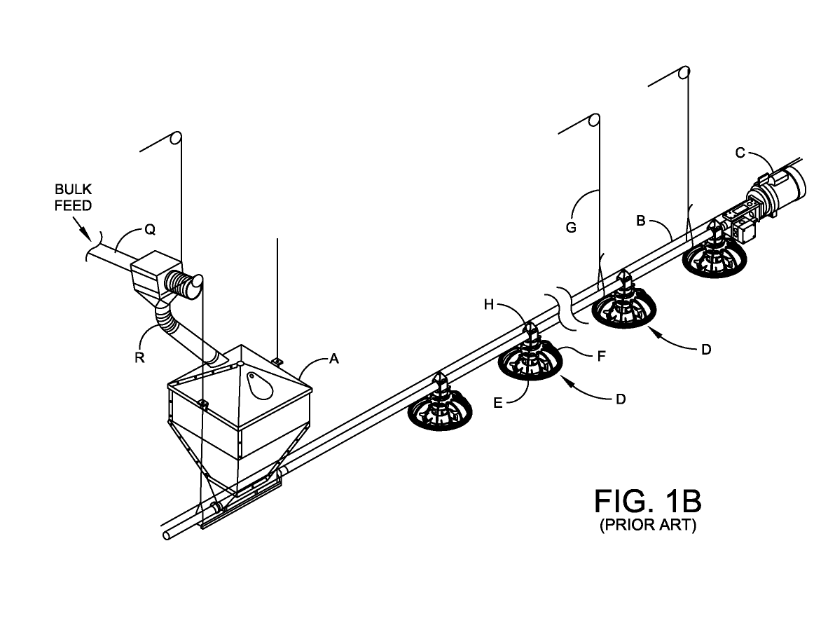

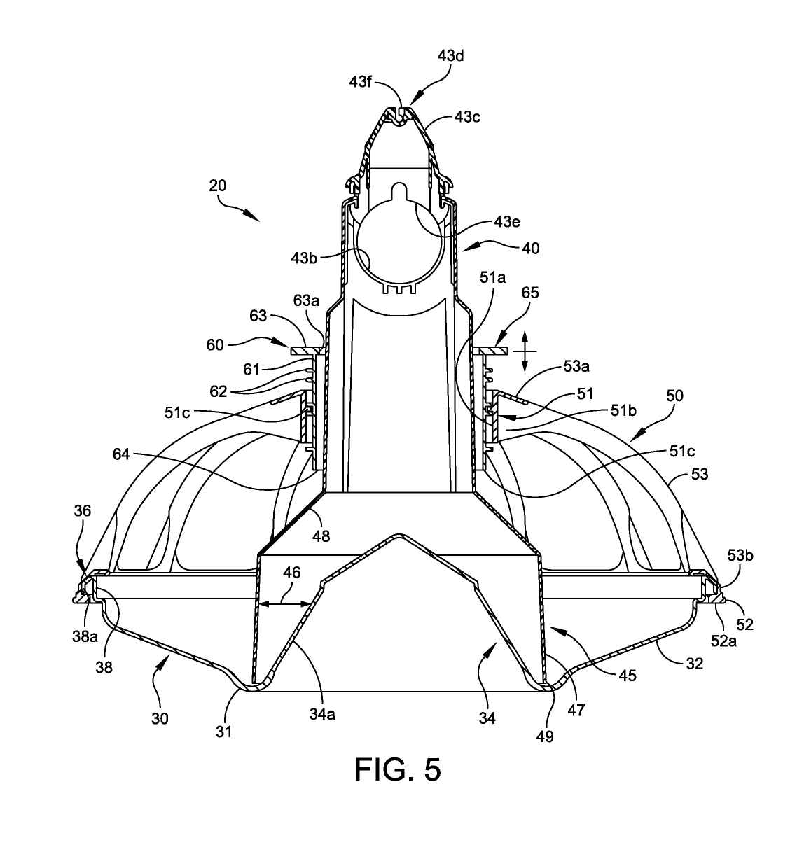

FIGS. 5-7 show one embodiment of a poultry feeder 20 according to principles of the present invention. A plurality of poultry feeders 20 may be supported and suspended from a conventional poultry feed system as shown in FIG. 1, and include the various system components and functionality already described herein in the Background of the Invention.

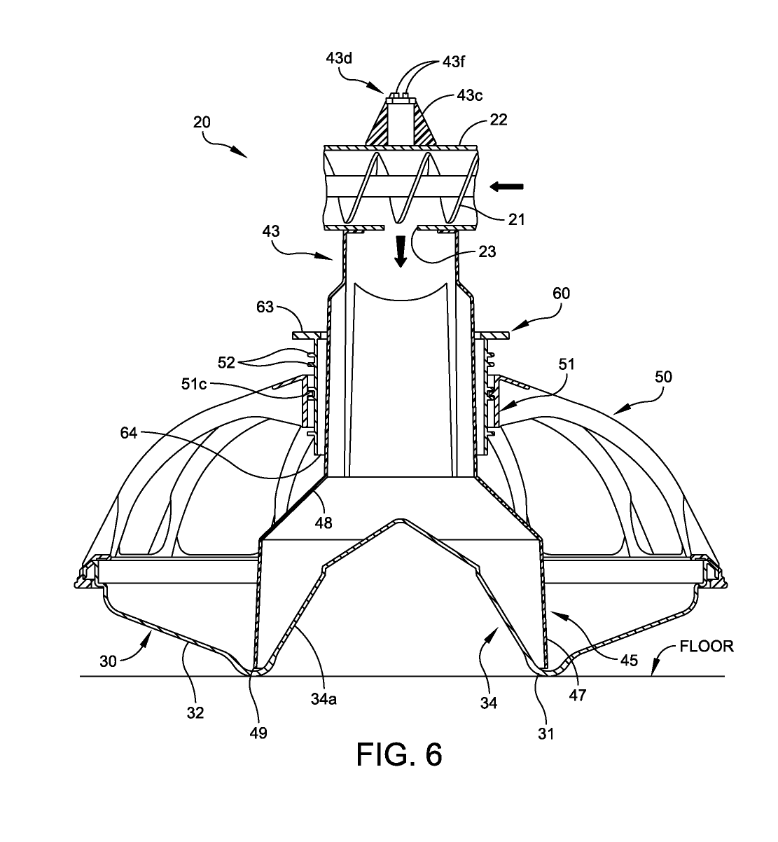

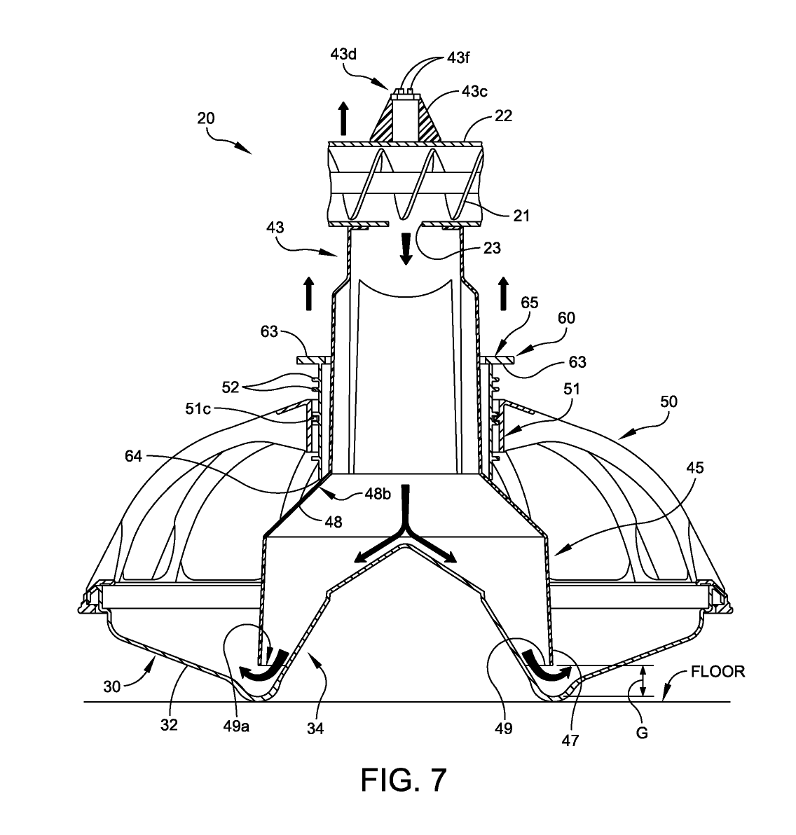

Referring to FIGS. 5-7, poultry feeder 20 generally includes a feeder pan 30, a vertically elongated feeder tower 40 centrally positioned with respect to the feeder pan, and a grill assembly 50 positioned over the feeder pan. Feeder tower 40 projects vertically upwards with respect to the feeder pan as shown. Feeder tower 40 is axially movable in a vertical direction with respect to feeder pan 30 from a lowered closed or shutoff position shown in FIG. 6 to a raised or upper open dispensing position shown in FIG. 7. In the lowered closed position, the feeder tower 40 engages the feeder pan 30 to preclude feed from entering the feeder pan.

It will be appreciated that various alternative configurations of feeder pans 30, feeder towers 40, and cage assemblies may be provided. According, the invention is not limited to the specific embodiments shown and described herein.

Feeder pan 30 in one embodiment includes a circumferentially extending and upwardly flared bowl portion 32 defining a receptacle for holding feed, a central portion 34 extending upwardly from the bowl portion, and an outer peripheral portion 36 for mounting grill assembly 50, as shown in FIGS. 5-7. Bowl portion 32 may define a support base 31 configured so that feeder pan 30 may rest squarely on the ground. Base 31 may be annular in shape in some embodiments. Peripheral portion 36 defines a peripheral annular-shaped rim 38 to which grill assembly 50 removably attaches in one embodiment. Central portion 34 may be generally conical-shaped with inwardly angled walls 34a that extend circumferentially and is positionable inside feeder tower 40.

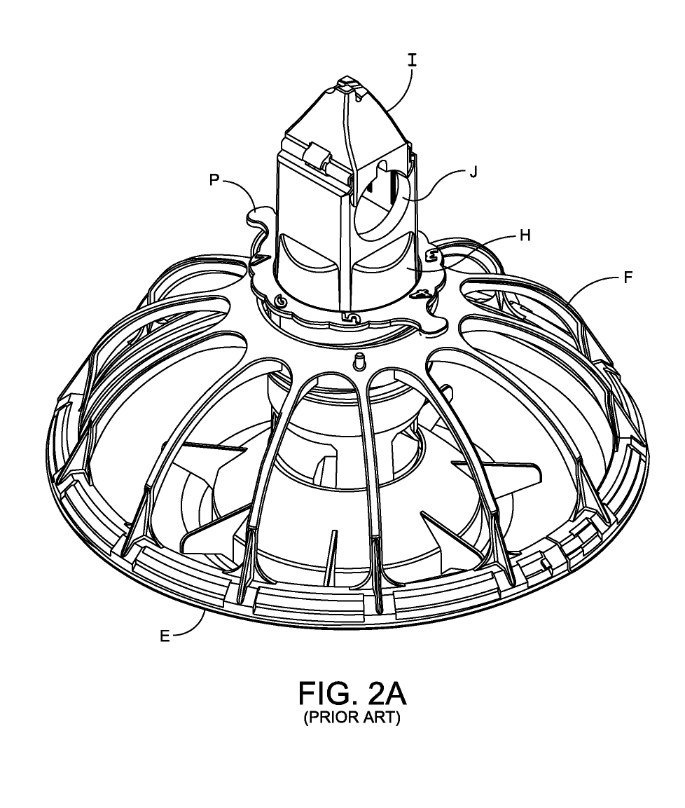

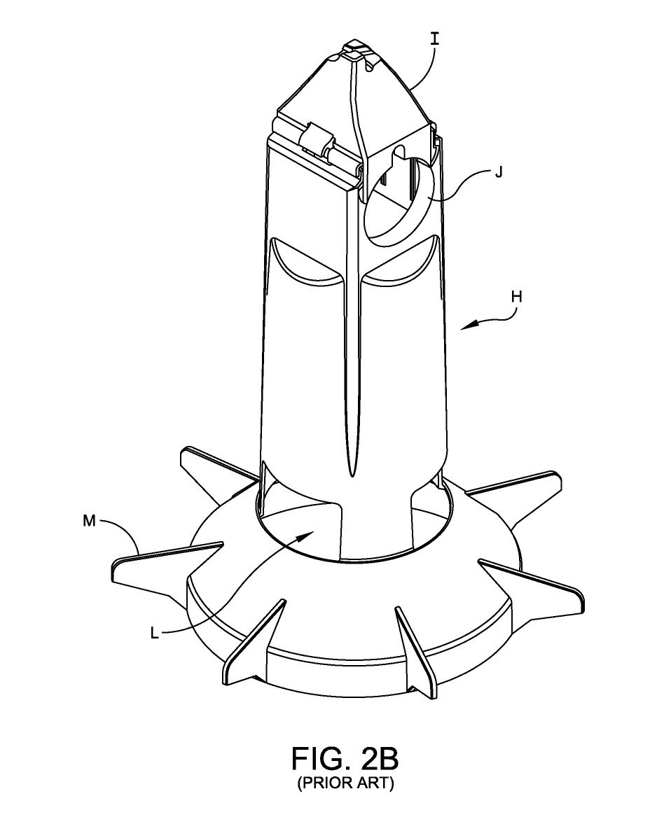

In one embodiment, bowl portion 32 of feeder pan 30 may be generally circular in shape when viewed from the top (similar to feeder pan E shown in perspective view in FIG. 2A). In other embodiments, bowl portion 32 may have any other suitable configuration including polygonal, oval or ellipsoidal, or various other shapes and compound shapes. Accordingly, the invention is not limited by the shape of feeder pan 30 provided.

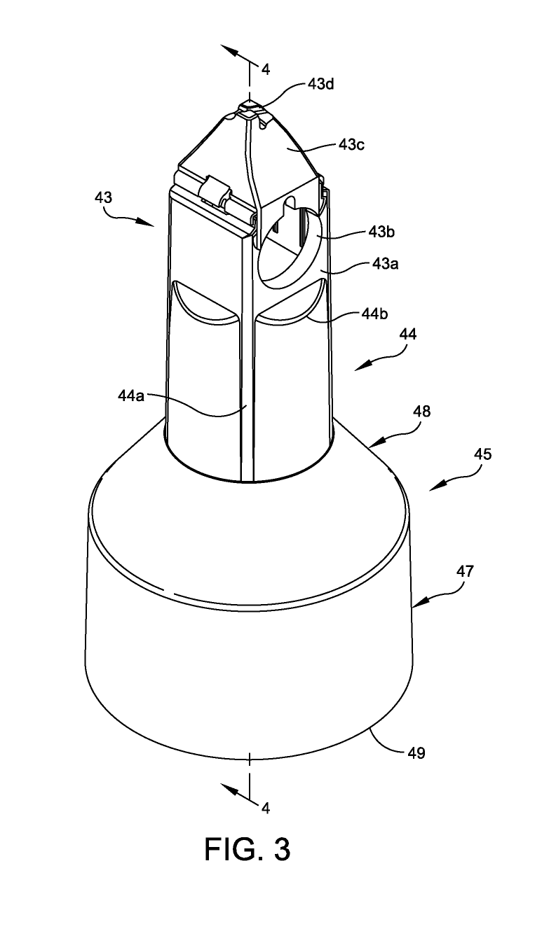

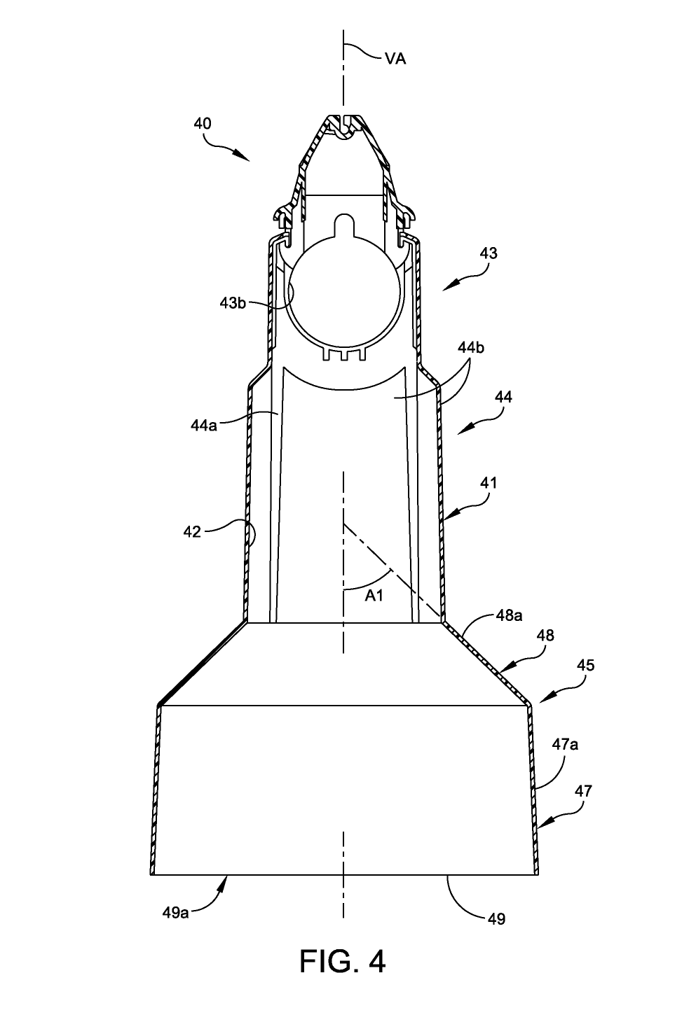

FIGS. 3 and 4 show perspective and cross-sectional views of feeder tower 40, respectively. Referring to FIGS. 3-7, feeder tower 40 defines a vertical axis VA and may be a substantially hollow structure having vertically and circumferentially extending sidewalls 41 defining an open central passageway 42 for receiving feed and dispensing feed to the feeder pan 30 positioned below. Feeder tower 40 may include an upper feed inlet portion 43, a diametrically enlarged lower skirt portion 45, and a middle portion 44 disposed therebetween. In one embodiment, skirt portion 45 has a larger lateral cross-section area than inlet and middle portions 43 and 44, respectively. Lower skirt portion 45 terminates with an open bottom end 49 having an annular bottom edge 49a. Bottom end 49 is selectively and axially movable to engage feeder pan 30. Preferably, bottom end 49 and feeder pan 30 are mutually configured to avoid any appreciable gaps therebetween when end 49 of feeder tower 40 is seated and engaged with the pan in the closed position to preclude feed from entering the pan from the tower. In one preferred embodiment, the sidewalls 41 of feeder tower 40 in the lower skirt portion 45 and middle portion 44 are solid without any openings so that feed is only dispensed to feeder pan 30 through the open bottom end 49 of the feed tower.

Lower skirt portion 45 is preferably configured and dimensioned to be laterally spaced apart from conical central portion 34 of feeder pan 30, as shown in FIGS. 5-7. This defines a generally annular space 46 within open central passageway 42 of the feeder tower 40 that extends laterally between angled walls 34c of central portion 34 and walls 47a and 48a of skirt portion 45 through which feed flows into feeder pan 30 (see FIG. 7).

Referring to FIGS. 3-7, lower skirt portion 45 of feeder tower 40 in one embodiment includes a cylindrical section 47 defining a circumferentially extending vertical wall 47a and an adjoining sloped transition section 48 between cylindrical section 47 and middle portion 44 of tower 40. Cylindrical section 47 has an open tubular shape and a generally constant diameter in some embodiments from top to bottom as shown.

In some embodiments, transition section 48 of feeder tower 40 may be frusto-conical shaped as shown in FIGS. 3-7 having a circumferentially extending angled radial wall 48a that is sloped inwardly at an angle A1 with respect to vertical axis VA as shown in FIG. 4. Transition section 48 varies in diameter from top to bottom, and in the embodiment shown, is narrowest at top adjoining smaller diameter middle portion 44 and widest at the bottom adjoining larger diameter cylindrical section 47 of the lower skirt portion 45.

Feeder tower 40 further includes a vertical travel limit or stop surface 48b for operably engaging adjusting collar 60 when feeder tower 40 is in the open position shown in FIG. 7. The travel stop surface 48b restricts the maximum vertical distance that feeder tower 40 may be raised above and relative to feeder pan 30, thereby limiting the size of gap G formed between bottom end 49 of the feeder tower and the pan in the open position.

In one possible embodiment, angled wall 48a of transition section 48 described above may provide the travel stop surface 48b, which is oriented and dimensioned to make annular contact with bottom end 64 of adjusting collar 60. In alternative embodiments, as will be readily understood by those skilled in the art without need for graphic illustration, transition section 48 may simply comprise a stepped configuration formed by an annular flat horizontal surface bridged between larger diameter cylindrical section 47 of lower skirt portion 45 and smaller diameter middle portion 44 (reference FIG. 4). In this case, the flat annular surface of the step may form the travel stop surface on feeder tower 40.

In other embodiments (not shown), the travel stop surface 48b may be formed by any other suitably configured and dimensioned radially or laterally extending surface having an angle A1 greater than 0 degrees but less than 180 degrees measured from the vertical axis VA as indicated in FIG. 4 to enable the stop surface to engage the bottom end 64 of adjusting collar 60 as shown in FIG. 7. Suitable configurations of a travel stop surface disposed on feeder tower 40 that are contemplated may include without limitation protrusions, flanges, fins, tabs, lugs, pins, shoulders, stepped-shaped portions, etc. so long as the stop surface has a dimension and angle suitable to operably engage adjusting collar 60 when the feeder tower is in the raised open dispensing position shown in FIG. 7 for limiting the size of vertical gap G between the feeder tower and feeder pan 30.

Referring to FIGS. 3-7, middle portion 44 of feeder tower 40 may have a generally rectilinear configuration with two pairs of opposing walls 44a. Middle portion 44 may further include arcuate sections 44b in some embodiments as shown, which may be formed as outwardly extending curved protrusions of walls 44a and form a transition to the generally circular shaped top opening of sloped transition section 48 of feeder 20. In one embodiment, inlet portion 43 may be defined as a plain top portion of walls 44a above the location where arcuate sections 44b terminate so that the inlet portion comprises essentially two pairs of opposing flat walls 43a as shown in FIGS. 3 and 4. Inlet portion 43 receives feed from feed conveyor tube 22.

FIGS. 6 and 7 show poultry feeder 20, and specifically feeder tower 40 mounted to a portion of a poultry feeder system of the type shown in FIG. 1. Preferably, feeder tower 40 is suspended from feed conveyor tube 22 in one embodiment so as to be vertically movable in unison with raising and lowering of feed conveyor tube 22, as further described herein. Feeder tower 40 is preferably vertically movable independently of the feeder pan 30, adjusting collar 60, and grill assembly 50 which are interconnected.

Accordingly, referring to FIGS. 3-7, upper feed inlet portion 43 of feeder tower 40 is configured with a mounting assembly for releasable mounting to feed conveyor tubes 22. In one embodiment, the mounting assembly comprises one pair of opposing and spaced apart walls 43a of upper feed inlet portion 43 having partial mounting holes 43b configured for passing feed conveyor tube 22 therethrough and a releasable cap 43c. A bottom portion of cap 43c contains an arcuate cutout 43e which combines with partial hole 43b in wall 43a to form a complete circular opening when the feeder tower cap 40 is mounted to feed conveyor tube 22 and open top of feed inlet portion 43, as shown. Feeder tower 40 is thus releasably retained to feed conveyor tube 22 by cap 43c (best shown in FIGS. 3-5). The top of cap 43c may include an anti-roost wire support assembly 43d that is configured and dimensioned to slidably receive therethrough and hold an anti-roost wire K (see in FIG. 1) in conventional fashion. In one embodiment assembly 43d may include a lateral through opening defined by a pair of opposing pair of ledge elements 43f that extend over the anti-roost wire K. In some embodiments, anti-roost wire K may be electrified. Other suitable arrangements for supporting anti-roost wire K may be used.

Feed conveyor tube 40 houses a rotating helical conveyor or auger 21 positioned therein for transporting feed from a feed hopper A (see FIG. 1) to each of the individual feeders 20. The bottom of feed conveyor tube 22 contains an aperture 23 which communicates with central passageway 42 of feeder tower 40 for filling the tower with feed transported by the feed conveyor tube.

Referring to FIGS. 5-7, grill assembly 50 includes an upper hub 51 having a cylindrical shape with an open center forming an inner circular wall 51a and an outer circular wall 51b. The inner wall 51a has a diameter that is sized to permit the feed tower 40 and an adjusting collar 60 to be received therethrough, as further described herein. Accordingly, the hub 51 encircles the feeder tower 40 and adjusting collar 60 in one embodiment when feeder 20 is assembled. A plurality of radially extending and circumferentially spaced apart ribs 53 is provided that project downwardly and outwardly from hub 51. The spaces between ribs 53 provide a lateral opening through which the birds may feed from the feeder pan 30. Ribs 53 have an upper end 53a attached to or formed as a unitary part of hub 51 and a lower end 53b attached to or formed as a unitary part of an annular shaped mounting ring 52 that extends circumferentially. Mounting ring 52 attaches the grill assembly 50 to feeder pan 30. In one embodiment, ribs 53, hub 51, and mounting ring 52 are preferably molded as a single unitary structure.

As shown in FIGS. 5-7, mounting ring 52 on grill assembly 50 is preferably configured and structured to interlock with feeder pan 30. In one possible embodiment, mounting ring 52 may include an inwardly curved or turned lip 52a that releasably engages an outwardly and downwardly turned mating lip 38a on peripheral rim 38 of feeder pan 30. Lip 38a may be generally configured as an inverted “U” in some embodiments as shown. Grill assembly 50 and feeder pan 30 are therefore preferably separable. In some embodiments, annular mounting ring may not form a continuous circle, but may include a split or opening (not shown) to provide lateral flexibility to the rim allowing it to be snap-fit onto peripheral rim 38 on feeder pan 30.

It will be appreciated that grill assembly 50 may be attached to feeder pan 30 in numerous suitable ways other than expressly shown and described herein.

Poultry feeder 20 further includes an adjusting collar 60 shown in FIGS. 5-7. Adjusting collar 60 allows a user to preset the maximum vertical gap G formed between the bottom end of feeder tower 40 and feeder pan 30 when the feeder tower is in the raised open position, as shown in FIG. 7. Adjusting collar 60 has a generally tubular configuration with two open ends and is rotatably mounted on grill assembly 50. In one embodiment, adjusting collar 60 defines a circumferentially extending vertical wall 61 having an axial length, an open bottom end 64, and an open top end 65. Top end 65 may include a radially protruding operating flange 63 that may be used to rotate adjusting collar 60. Operating flange 63 has a central aperture 63a through which feeder tower 40 may axially move or slide. In some embodiments, operating flange 63 may include alphanumerical indicia similar to operating ring P shown in FIG. 2A to assist a user with repeatability in making collar settings that in turn regulates the gap G and amount of feed dispensed by feeder tower 40 into feed pan 30, as further explained herein.

To rotatably support and couple adjusting collar 60 to hub 51 of grill assembly 50, vertical wall 61 of adjusting collar 60 as shown in FIGS. 5-7 may have an outer surface with a helical thread 62 that threadably engages a mating helical thread 51c having a matching pitch that is formed on inner circular wall 51a of hub 51 of the grill assembly 50. As shown, threads 62 and 51a may be coarse threads axially spaced widely apart having for example, without limitation, a thread pitch of about 1 inch. In one embodiment, threads 62 may be configured as a closely spaced apart (axially) double thread configured and dimensioned to receive a single mating thread 51c therebetween.

Collar 60 preferably has an outside diameter that is smaller than the inside diameter of hub 51, but an inside diameter that is larger than the outside diameter of middle portion 44 of feeder tower 40 so that the feeder tower may move axially freely through the collar. The adjusting collar 60 is axially movable up and down in a vertical direction and freely rotatable with respect to feeder tower 40 which can move axially up or down within and independently of the collar without restriction (compare, e.g. FIGS. 6 and 7).

Rotating adjusting collar 60 axially moves and adjusts the vertical position of the collar with respect to grill assembly 50 and hub 51 via the threaded engagement between the collar and grill assembly. Referring to FIGS. 5-7, rotating adjusting collar 60 in opposing rotational directions causes bottom end 64 of the collar to be selectively projected from or retracted into collar hub 51 by a continuously variable distance, thereby allowing a user to adjust the distance that bottom end 64 extends beyond bottom end 51c of grill hub 51. This enables bottom end 64 of adjusting collar 60 to act as a vertical limit stop for feeder tower 40 which is vertically, axially moveable with respect to the collar and feeder pan 30. Concomitantly, adjusting collar 60 allows the user to regulate the size of gap G and amount of feed that is delivered to feed pan 30 when the feeder 20 is operated. A user may therefore use adjusting collar 60 to preset the maximum gap G formed when feeder tower 40 is in the open position shown in FIG. 7.

Referring to FIG. 7, the bottom end 64 of adjusting collar 60 engages and rests on travel stop surface 48b formed by a portion of feeder tower 40 when the tower is raised with feed conveyor tube 22. In one embodiment, without limitation, the stop surface 48b may be formed by angled wall 48a of the frusto-conical shaped transition section 48 (see FIGS. 3 and 4). The relative positions between a bottom end 49 of the feeder tower 40 and the feeder pan 30 is adjustable in a plurality of varying open positions by in turn adjusting the position of adjusting collar 60 with respect to grill hub 51 as described elsewhere herein. Each of these positions provides a different opening or gap G between the bottom end 49 of the feeder tower and the pan 30. Accordingly, increasing or decreasing the maximum distance between the feeder tower bottom end 49 and feeder pan 30 when feeder tower 40 is in the open position (see FIG. 7) via adjusting collar 60 concomitantly controls the amount of feed entering and level of feed in pan 30.

An exemplary method for operating poultry feed system according to principles of the present invention will now be described. The feed system may be generally configured as the conventional system shown in FIG. 1. However, a plurality of innovative poultry feeders 20 according to embodiments of the present invention having feed shutoff capability is instead provided in lieu of feeders D shown. Feeders 20 are suspended and supported from feed conveyor tube 22.

Referring now to FIGS. 1 and 5-7, poultry feeders 20 are mounted so at to be suspended from a respective feed conveyor tube 22 of a feed conveyor system in the manner previously described. Gravity urges the feeder pan 30, grill assembly 50, and adjusting collar 60 downward with respect to the feeder tower 40 which is independently supported by feed conveyor tube 22 and freely movable axially in a vertical direction with respect to the feeder pan, grill assembly, and collar. In one embodiment, each feeder tower 40 is preferably rigidly attached to their respective feed conveyor tube 22. Accordingly, feeder towers 40 may be operably raised and lowered in unison with raising and lowering of the feed conveyor tubes 22.

To initially setup the poultry feeding system before initiating a feeding cycle, each feed conveyor tubes 22 with network of attached poultry feeders 20 is first initially lowered and positioned using the winch motor N system previously described (see FIG. 1) so that the feeder pans 30 of the feeders 20 become located on and supported by the floor of the poultry house, as shown in FIG. 6. The feed conveyor tubes 22 are in their lowermost vertical position being spaced above the ground by a distance approximately equal to the height of the feeder assemblies 20.

As shown in FIG. 6, feeder tower 40 is initially in its lower closed or shutoff position with respect to feeder pan 30. Bottom edge 49a defined on bottom end 49 of lower skirt portion 45 is engaged with an inside surface on feeder pan 30 to prevent an outflow of any feed in the feeder tower into the pan. In the embodiment shown, bottom end 49 engages a surface on bowl portion 32 of feeder pan 30 at the base perimeter of conical portion 34. Accordingly, there preferably is no appreciable gap or opening between feeder tower 40 and feeder pan 30 to effectively fill the pan with feed. The feed supply to feeder pan 30 is therefore shut off.

With the feeder tower 40 in the closed or shutoff position in FIG. 6, the network of feed conveyor tubing 22 and feeders 20 may be fully charged with feed via operating the helical auger 21 (see feed flow arrows). To perform this step, the auger 21 drive motor C (see FIG. 1) is first actuated to rotate the auger 21, wherein feed is transported from feed supply hoppers A through the network of feed conveyor tubing 22 and then discharged into the individual feeder towers 40 to preferably fully charge the feed system and towers with feed (reference FIGS. 1 and 6). Once the feed system is fully charged, the auger 21 drive motor C may be stopped.

Since feeder tower 40 is in the closed or shutoff position engaged with feeder pan 30 as shown in FIGS. 5 and 6, essentially no feed flows into the feed pan from the feeder towers 40. In addition, it will be appreciated that since the feeder towers 40 are rigidly mounted to feed conveyor tube 22 in the present embodiment, the weight of the feed conveyor tubing 22 network and feed supply hoppers A (hung from the motorized winch N system by the series of pulleys O and support wires G as shown in FIG. 1) helps to push or force the feed towers 40 downward tightly against the bowl portion 30 of the feeder pans 30 to the greatest extent practicable to minimize any leakage of feed into pan 30.

With the poultry feeding system fully charged with feed, a feeding cycle may next be initiated. The birds may be fed by raising the feeder towers 40 upward with respect to feed pan 30 to their raised upper open or dispensing position shown in FIG. 7. This step may be performed by actuating the motorized winch N system shown in FIG. 1 to raise the network of feed conveyor tubing 22. This simultaneously raises feeder towers 40 which are hung from the tubes 22 (see directional arrows in FIG. 7). Each feeder tower 40 slidably moves upward through feeder 20 relative to the feeder pan 30, adjusting collar 60, and grill assembly 50 which are interconnected and remain stationary on the floor of the poultry house. Accordingly, feeder pan 30 remains stationary and in contact with the floor of the poultry house as the feeder towers 40 are lifted as shown.

In one embodiment of the operating method, feeder tower 40 is raised (via and together with feed conveyor tubing 22) until travel stop surface 48b engages open bottom end 64 of adjusting collar 60 as shown in FIG. 7. In one embodiment, a portion of sloped transition section 48 (specifically angled wall 48a) of lower skirt portion 45 forms stop surface 48b that engages bottom end 64 of adjusting collar 60. Feeder tower 40 is operably now in a fully open/dispensing position. Bottom end 49 is separated from feeder pan 30 by a vertical distance or gap G as shown (compare FIG. 6). Feed now flows freely by gravity outwards through open bottom end 49 of feeder tower 40 and gap G into feeder pan 30 (see directional arrows) since the bottom edge 49a at is now raised above and spaced apart from the inside bottom of the feeder pan as shown. In conventional fashion, feed will enter feeder pan 30 and fill to a level corresponding to the height of bottom edge 49a of feeder tower 40 above the feeder pan.

Bottom end 64 of feeder tower 40 acts as an axially adjustable vertical travel limit stop for feeder tower 40 that prevents further relative movement of the feeder tower with respect to feeder pan 30 assembly including adjusting collar 60 and cage assembly 50. With travel stop surface 48b of angled wall 48a on the feeder tower 40 now engaged with bottom end 64 of adjusting collar 60 as shown in FIG. 7, further rising of the feeder tower will also concomitantly raise the whole feeder 20 assembly including the adjusting collar, grill assembly 50 and feeder pan 30. The axial gap G between bottom end 49 of feeder tower 40 and the inside bottom of feeder pan 30, however, will remain the same and fixed by the position of the open bottom end 64 of adjusting collar 60 regardless of the height to which feeder 20 may be raised above the floor.

To adjust the level of feed in feeder pan 30 preferably before feeding time, the adjusting ring 60 may be rotated by a user in opposing rotational directions which translates into raising or lowering axial motions respectively of the adjusting ring bottom end 64 in relation to the feeder pan. This ultimately limits the size of gap G and maximum height that the bottom end 49 of feeder tower 40 may be raised above feeder pan 30 as shown in FIG. 7.

In one possible operating mode if the intent is to feed young birds, the feeder towers 40 are raised upward only to the vertical position shown in FIG. 7 wherein the feeder pans 30 remain resting on the floor so that the birds can reach the feed.

Alternatively, in another possible operating mode if the intent is to feed more mature birds, the feeders 20 may be raised to a vertical position higher than shown in FIG. 7 so that the feeder pans 30 are elevated above the floor by a predetermined distance. The feeder, however, will remain in the fully open position shown in FIG. 7 with the axial distance between open bottom end 64 of feeder tower 40 and feeder pan 30 remaining fixed. The height of the feeder pan 30 above the floor will be dictated by the size of the birds and selected so that the birds may readily access the feed in the pans.

Once the feeding cycle is completed, the poultry feeders 20 are returned to their fully closed position shown in FIG. 6 by reversing the operation described above. In essence, the feed conveyor tubing 22 is lowered which simultaneously lowers and returns feeder towers 40 to their lower closed/shutoff positions as shown. Bottom end 49 of now empty feeder tower 40 is engaged with feeder pan 30 and gap G is eliminated. Next, the auger 21 may be actuated and rotated again fully charge the feed feeder towers 40 with feed. Once the feeder towers 40 are filled, the auger may be stopped. The poultry feeding system is now fully charged and ready to begin another feeding cycle.

In one preferred embodiment, the poultry feeder 20 and its constituent parts including feeder tower 40, grill assembly 50, and feeder pan 30 may be made of suitable polymer material that may be injection molded or formed by other processes commonly used in the art for making such parts.

According to another aspect of the invention, a further second embodiment of a poultry feeder is provided that has full feed shutoff capability, but functions generally in a reverse manner from the system described herein in which the feeder tower is vertically moveable with respect to a stationary feeder pan via raising or lowering the feed conveyor tube (see, e.g. FIGS. 6 and 7). Conversely, in the alternative embodiment, the feeder tower and feed conveyor tube may remain stationary while the feeder pan may be raised or lowered in relation to the feeder tower by a lifting mechanism, such as a winched-operated cable in some embodiments.

Cable-Operated Poultry Feeders

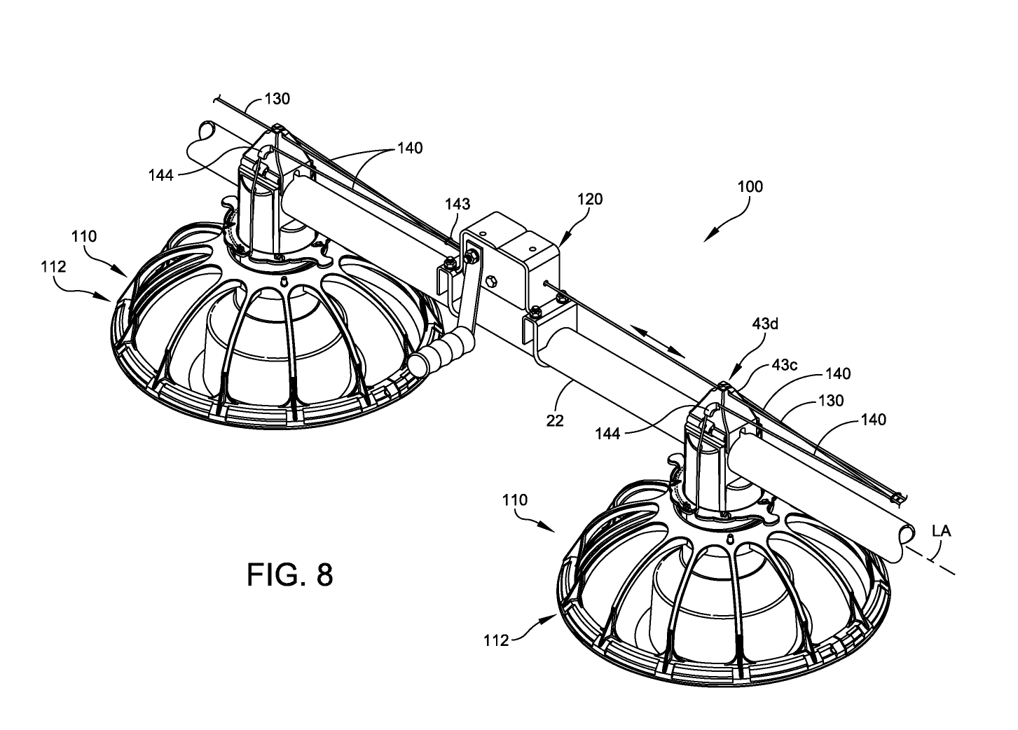

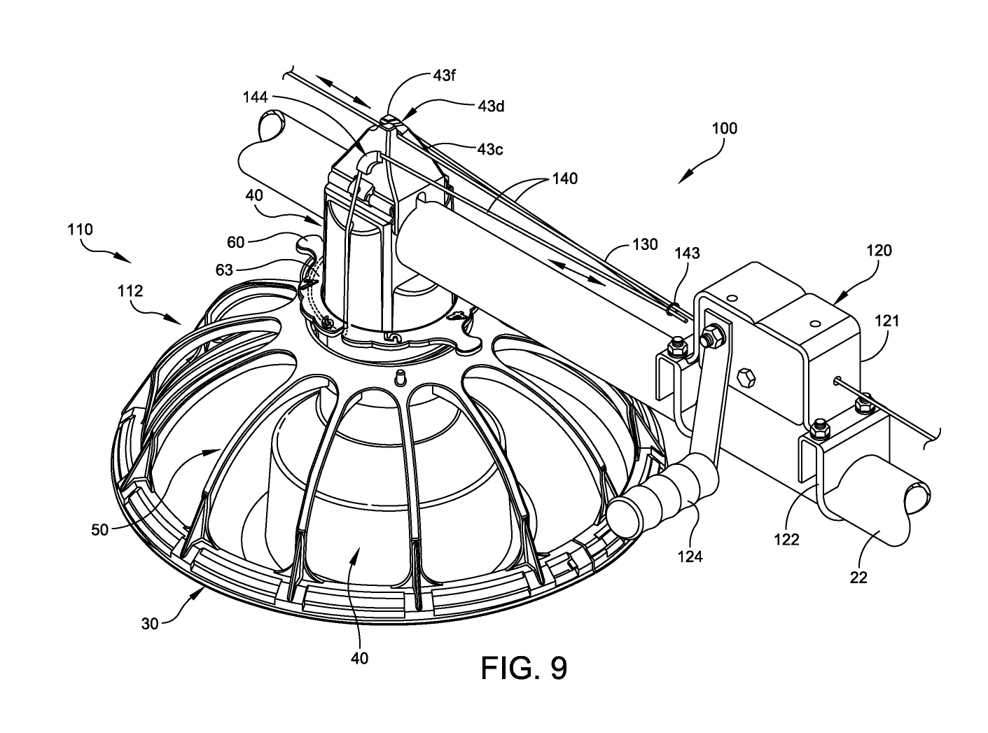

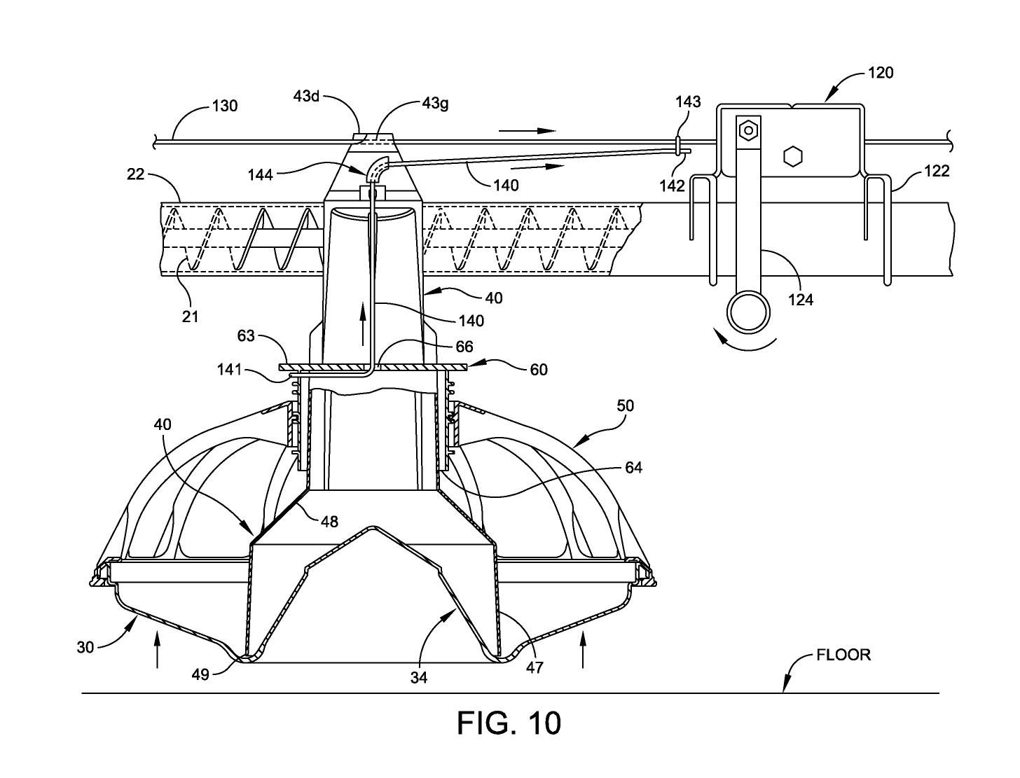

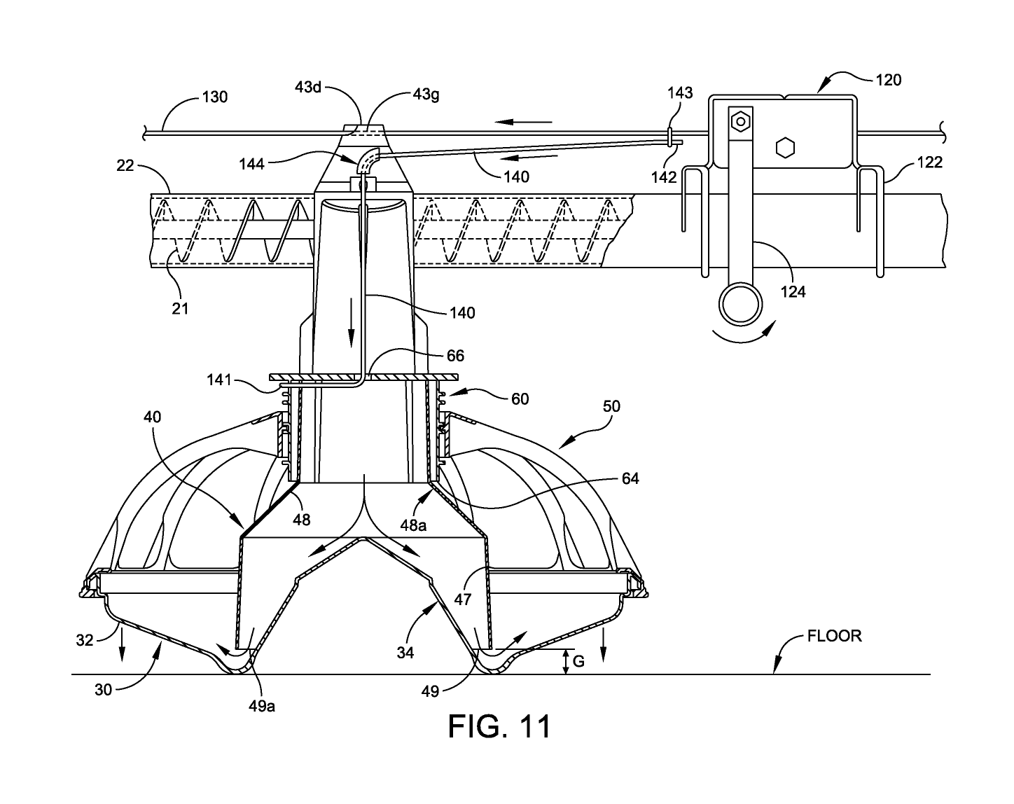

FIGS. 8 and 9 show one embodiment of a poultry feed system 100 having cable-operated poultry feeders 110. The system 100 includes feed conveyor tube 22 with a rotary auger 21 (see FIGS. 10-11), at least one winch 120, and a plurality of poultry feeders 110 suspended from tube 22 in a conventional manner as already described herein. The poultry feed system 100 may include a network of feed conveyor tubes 22, feeders 110, and other appurtenances as shown in FIG. 1 and described herein.

In one embodiment, cable-operated feeders 110 may be of the same design as feeders 20 described elsewhere herein with reference to FIGS. 3-7 and generally include feeder pan 30, feeder tower 40, grill assembly 50, and adjusting collar 60. In the present embodiment, however, feeders 110 are configured and adapted for cable actuated operation.

When feeder pan 30, grill assembly 50, and adjusting collar 60 are assembled together, as shown in FIGS. 8-11, these components collectively form a feeder pan assembly 112 that are coupled together so as to move as a single unit when any of these individual components are moved. Accordingly, raising or lowering either the feeder pan 30, grill assembly 50, or adjusting collar 60 alone will cause the entire feeder pan assembly 112 to be correspondingly raised or lowered as a unit. It should be noted, however, that adjusting collar 60 is still rotationally movable with respect to hub 51 of grill assembly 50 in the manner already described herein. This enables a user to vary the vertical position of bottom end 64 of the collar with respect to the feeder pan 30 and thereby regulate the amount of feed that can enter the pan from feeder tower 40 by adjusting the gap G between the pan and bottom end 49 of the tower (see FIGS. 7 and 11).

Referring to FIGS. 8 and 9, poultry feed system 100 includes a longitudinally-extending anti-roost wire 130, which may be routed in the axial direction of the feed conveyor tube 22 along longitudinal axis LA as shown. In one embodiment, anti-roost wire 130 may be positioned above feed conveyor tube 22. Anti-roost wire 130 is longitudinally moveable in opposing left and right axial directions (as viewed in FIGS. 8 and 9) with respect to feed conveyor tube 22.

With continuing reference to FIGS. 8 and 9, anti-roost wire 130 is threaded through and supported by cap 43c of the feeder towers 40 in the manner already described herein (see also FIGS. 5-7). In some embodiments, tower cap 43c may therefore include a pair of ledge elements 43f arranged in opposing relationship that extend over and help retain anti-roost wire 130 within a through opening 43g formed in the top of the cap (see also FIGS. 3 and 4). Anti-roost wire 130, supported by feeder towers 40, therefore is raised and lowered in unison with vertical movement of feed conveyor tube 22.

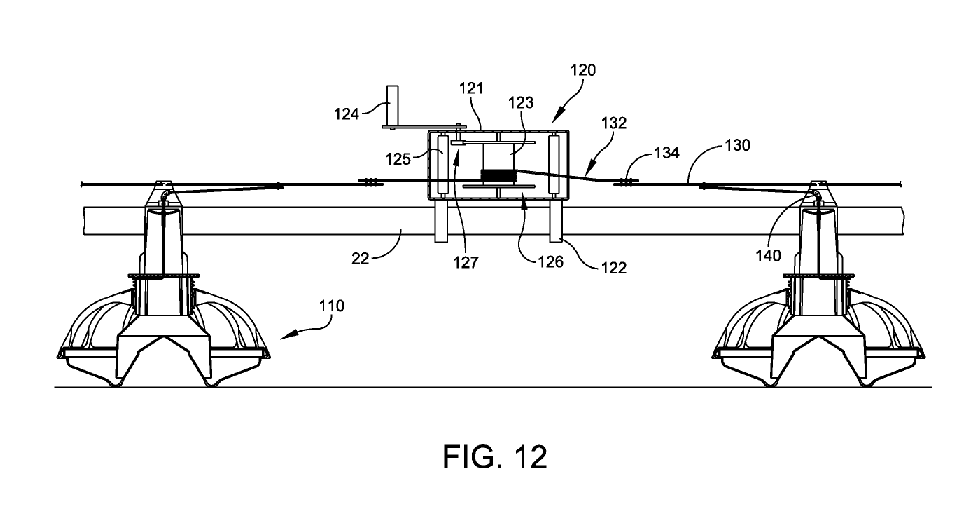

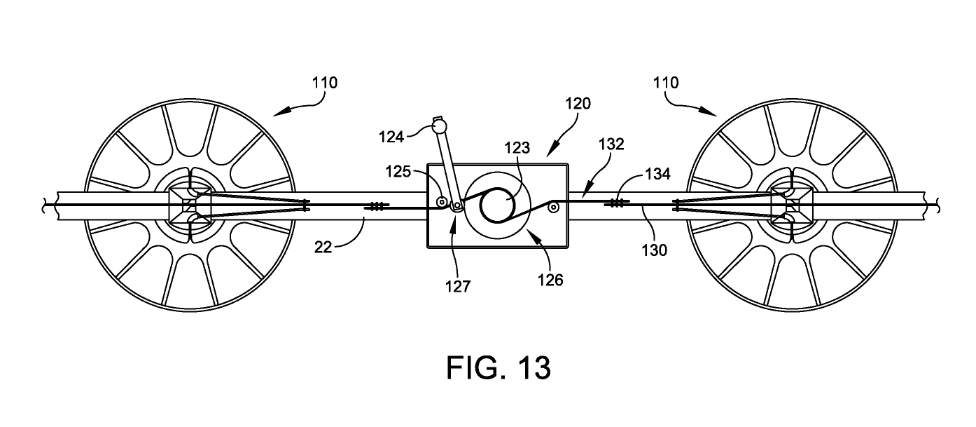

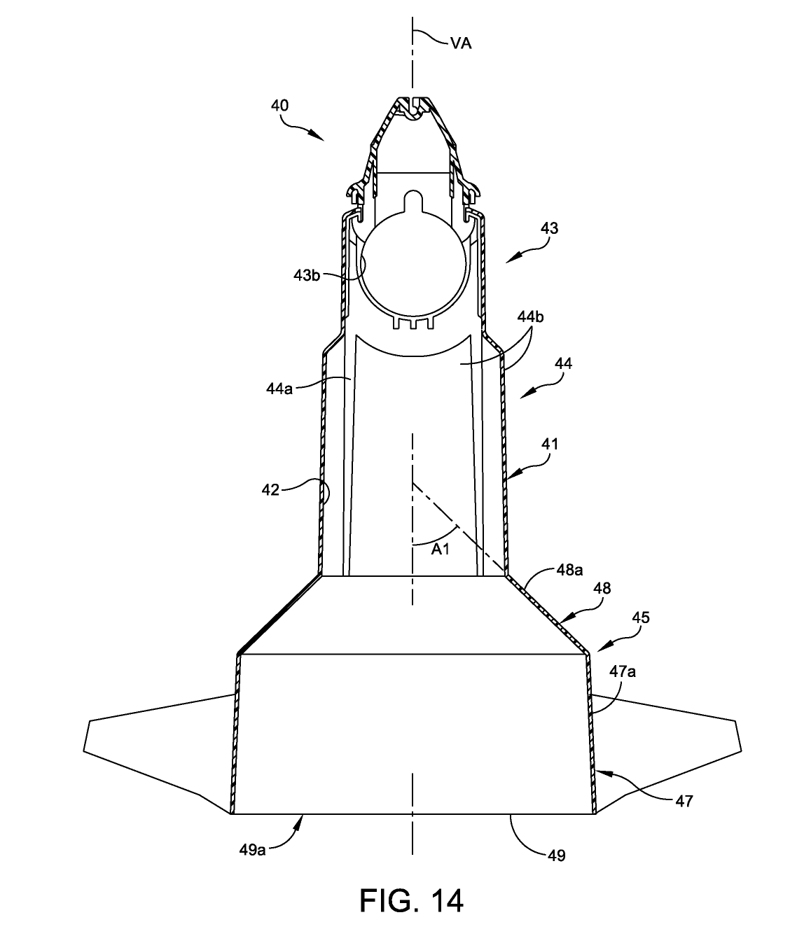

Anti-roost wire 130 may be operably coupled to a lifting mechanism, which in some embodiments may be a manual or powered winch 120. FIGS. 8-13 show possible embodiments of a manually-operated winch as a non-limiting example. Winch 120 includes a housing 121, a mounting bracket 122 disposed on either end configured and operable for attaching the housing to feed conveyor tube 22 (e.g. U-shaped pipe clamp in some embodiments), and an operating handle 124 coupled through the housing to a winch spool or drum 123 supported by housing 121. FIGS. 8-9 show winch 120 with operating handle 124 mounted on a side of housing 121 and FIGS. 12-13 show an alternative mounting of handle 124 on top of housing 121. Either is satisfactory.

To provide sufficient flexibility for conformance to the cylindrical winch drum 123, a relatively short length of a flexible and elastically deformable winch cable 132 may be attached between opposing ends of anti-roost wire 130 via wire clamps 134 as shown in FIGS. 12 and 13. This construction is advantageous in some embodiments where anti-roost wire 130 may be made of less elastically deformable solid metal wire which cannot readily conform easily to a circular path and be wound a number of times around winch drum 123 for repetitive winding and unwinding. Winch cable 132 may be wound several times around drum 123 as shown in FIG. 12 to secure the cable to the drum allowing for various lengths of cable 132 to be let out or pulled in from either side of winch 120 to raise/lower feeder pans 30.

Referring to FIGS. 12 and 13, winch 120 may further include a cylindrical roller 125 supported by housing 121 on either side of drum 123 to guide winch cable 132 with respect to the drum. Rollers may be fixed and non-rotatable in some embodiments, or rotatable about a central transverse axis of each roller to reduce wear as the cable 132 moves over or under the rollers.

Operating handle 124 is mechanically coupled to winch drum 123 via a conventional operating mechanism for operating winch 120 and rotating the drum in opposing directions depending on whether the handle is turned clockwise or counter-clockwise. The operating mechanism includes a drive member 127 which may be an annular or circular pinion gear coupled to the handle and rotatable therewith and a meshing driven member 126 which may be an annular or circular driven gear fixedly coupled to an end of winch drum 123 as shown in FIGS. 12 and 13. Drive and driven members 127, 126 may therefore be configured as circular toothed wheels in some embodiments shown having conventional meshing gear teeth arranged around the circumference of the wheels. Turning handle 124 winds winch cable 132 around drum 123 from one longitudinal direction and unwinds cable 132 from drum 123 in an opposing longitudinal direction depending on which way the handle is rotated. Drive and driven members 127, 126 may be made of any suitable durable material including metals or plastics.

Winch 130 therefore operates to move anti-roost wire 130 axially forward or rearward along longitudinal axis LA with respect to feed conveyor tube 22 by rotating the operating handle 124 in opposing rotational directions (e.g. clockwise or counter-clockwise as shown in FIG. 9 or 13 respectively).

Each feeder pan 30 is operably coupled to anti-roost wire 130 via an operating cable 140 as shown in FIGS. 8-11. Operating cable 140 is used to raise or lower the feeder pan 30 with respect to feeder tower 40 which is rigidly attached to feed conveyor tube 22. Operating cable 140 may engage and be secured to both a portion of feeder pan assembly 112 and also to anti-roost wire 130 which is used to raise and lower feeder pan 30 in unison with movement of the anti-roost wire. In one embodiment, operating cable 140 forms a closed loop which engages feeder pan assembly 112 and has a first end 141 and a second end 142 each rigidly fixed to anti-roost wire 130 to define the loop. In one embodiment, without limitation, the loop engages adjusting collar 60. As further described herein, raising or lowering adjusting collar 60 via operating cable 140 will concomitantly raise or lower the entire feeder pan assembly 112 including feeder pan 30. In other possible embodiments contemplated, therefore, operating cable 140 may be attached to the grill assembly 50 or feeder pan 30 to effectuate raising and lowering of the feeder pan.

Operating cable 140 preferably is made of metal and elastically flexible enough to conform to a curved route or path selected from anti-roost wire 130 to feeder pan assembly 112 without permanent plastic deformation, as best shown in FIGS. 8-11. Accordingly, operating cable 140 should preferably further have sufficient flexibility to be capable of movement to repeatedly raise or lower feeder pan 30 as further described herein. Winch cable 132 should have similar elastic flexibility for reasons discussed above to wrap in several convolutions around winch drum 123 without permanent deformation. Anti-roost wire 130 is also preferably made of metal, and may be of the same construction and type as operating cable 140. Suitable metals for cable 140, cable 132, and anti-roost wire 130 are steel, aluminum, copper, and nickel. In some embodiments without limitation cable 140 and/or anti-roost wire 130 may be formed of a single solid metal wire, a strand of wires, or cable formed of multiple strands of wires. In other possible embodiments, operating cable 140 may be made of non-metallic materials including without limitation nylon, polypropylene, or other polymeric monofilament or multiple filament lines or rope/twine. In one exemplary embodiment, anti-roost wire 130 may be made of 12.5 gauge solid galvanized wire and cables 140 and 132 may be made of ⅛ inch metal cable. Preferably, the materials selected are corrosion resistant.

In some embodiments, a cable guide 144 may be disposed on part of feeder 110 such as without limitation on cap 43c on feeder tower 40 which operates to transform the generally horizontal/lateral sloped path of cable 140 from the anti-roost wire 130 into a vertical path for more efficient raising and lowering motions to feeder pan assembly 112, as shown in FIGS. 9-11. Cable guide 144 may have any suitable configuration that accomplishes the foregoing objective. In one embodiment, without limitation, cable guide 144 may be configured as a protruding tab 145 shown in FIGS. 9-11 defining a hole forming a passageway therein for changing direction of the operating cable 140 from lateral/horizontal to vertical.

Operating cable 140 may engage adjusting collar 60 in any suitable manner so long as the cable is operable to provide raising/lowering action of feeder pan 30 via axial movement of the anti-roost wire 130. In one embodiment, as best shown in FIGS. 9-11, opposing lateral sides of flange 63 on adjusting collar 60 may each include a fastening hole 66 through which one end 141 of operating cable 140 may be inserted and is routed 180 degrees around feeder tower 40 beneath flange 63 of the collar 60. End 141 of cable 140 therefore is inserted down into one of the holes 66, loops 180 degrees around feeder tower 40, and then emerges from the remaining hole 66 on the opposing side of flange 63 (not visible in the figures). End 141 may be attached to anti-roost wire 130 with a conventional cable clamp 143.

With continuing reference to FIGS. 9-11, second end 142 of operating cable 140 may be also attached to anti-roost wire 130 with the same cable clamp 143 so that both ends 141, 142 are secured to the anti-roost wire. Accordingly, operating cable 140 and the loop formed by the present arrangement are moveable in unison with anti-roost wire 130 wherein axially moving the anti-roost wire in opposing left or right axial directions along longitudinal axis LA will cause feeder pan assembly 112 to concomitantly be raised or lowered with respect to feeder tower 40 and feed conveyor tube 22. Tension is maintained on operating cable 140 by the weight of poultry feeder 110 unit and any feed that may be present in the feeder at a given time. When the feeder pan 30 is resting on the floor of the poultry house as shown in FIG. 11, the tension in the operating cable will be at least partially relieved.

It will be appreciated that in possible alternative embodiments, one end 141 of operating cable 140 may be secured to adjusting collar 60 or another component of feeder pan assembly 112 while the remaining end 142 may be secured to anti-roost wire 130. Accordingly, the invention is not limited to the embodiments shown herein so long as the feeder pan 30 may be raised and lowered in unison with axial movement of the anti-roost wire 130.

An exemplary method for operating the cable-operated poultry feeders 110 according to principles of the present invention will now be described. The feed system may be generally configured as the conventional system shown in FIG. 1. However, a plurality of innovative cable-operated poultry feeders 110 according to embodiments of the present invention having feed shutoff capability is instead provided in lieu of feeders D shown. Feeders 110 are suspended and rigidly supported from feed conveyor tube 22.

Similar to the poultry feeder system using feeders 20 previously described herein, gravity urges the feeder pan assembly 112 including interconnected feeder pan 30, grill assembly 50, and adjusting collar 60 downward as a unit with respect to the feeder tower 40 which is independently and rigidly supported by feed conveyor tube 22. Feeder pan assembly 112 is therefore freely movable axially in a vertical direction with respect to the feeder tower 40 via operating cable 140.

To initially setup the poultry feeding system before initiating a feeding cycle, the first step is to vertically position feeder pan assembly 112 at the desired elevation. Each feed conveyor tube 22 with network of attached poultry feeders 20 is first initially positioned using the main feed conveyor tube winch motor N system previously described (see FIG. 1) so that the feeder pans 30 of feeders 110 when in the lowered fully open position (shown in FIG. 11) are positioned at the desired feeding elevation with respect to the floor of the poultry house based on the age of the birds. In some embodiments, the feeder pan may be located on the floor in a lowered fully open lowered feeding position as shown in FIG. 11, or alternatively at an elevated position raised off the floor from the position shown in FIG. 11. Preferably, the feeder 110 and particularly feeder tower 40 are vertically positioned so that the feeder pan 30 may be lowered from the upper raised closed position shown in FIG. 10 to a lowered fully open position shown in FIG. 11 without interference from the floor.

Advantageously, it should be noted that once the proper vertical position of feeder 110 is setup in the foregoing manner, the feed conveyor tube 22 and feeder tower 40 may remain stationary and fixed throughout performance of a feeding cycle as described below. Therefore, the feed conveyor tube 22 requires no further adjustment in vertical position unless the operator desires to change the feeding position of feeders 110, and particular feeder pan 30 (shown in FIG. 11) as the birds grow. Accordingly, the main system motorized winch N (see FIG. 1) is not needed simply to initiate a feeding cycle which provides energy savings.

Once the feed conveyor tubes 22 and feeder towers 40 are placed at the foregoing desired and stationary vertical operating position, feeder pan assembly 112 is vertically moved to the raised closed position in which the bottom end 49 of feeder tower 40 engages the feeder pan 30 as shown in FIG. 10. In one embodiment, this may be performed by moving anti-roost wire 130 in a first horizontal axial direction along longitudinal axis LA (e.g. to the right shown in FIG. 10). This pulls operating cable 140 in the same first axial direction, which concomitantly raises cable 140 upwards thereby lifting adjusting collar 60 vertically. Since the adjusting collar 60 is interconnected with grill assembly 50 and feeder pan 30 to define feeder pan assembly 112 to move as a unit, the grill assembly and feeder pan concomitantly are simultaneously raised vertically with adjusting collar. Feed conveyor tube 22 with coupled feeder tower 40 remain stationary during the foregoing vertical movement of feeder pan assembly 112 to the raised closed position.

It should be noted that feeder pan 30 is preferably elevated off the floor of the poultry house when feeder 110 is in the closed position, regardless of whether the feeder pan will ultimately be resting on the floor or elevated when in the open feeding position shown in FIG. 11, to ensure proper operation of the feeder 110.

With feeder pan assembly 112 now in the closed position shown in FIG. 10, the method continues by filling the feeder tower 40 with feed from feed conveyor tube 22 by operating the auger 21 to transport feed from feed supply hopper (shown in FIG. 1) to feeders 110. Feed is prevented from flowing into the feeder pan 30 by the engagement between the bottom end 49 of feeder tower 40 and the pan. This fully charges the feeder tower 40 with feed in anticipation of starting a feeding cycle, Auger 21 may then be stopped once the feeder towers 40 are filled.

To initiate a feeding cycle, the method next continues with lowering the feeder pan assembly 112 to a second lowered open or feeding position shown in FIG. 11 in which the bottom end 49 of feeder tower 40 disengages the feeder pan 30. In one embodiment, this may be performed by moving anti-roost wire 130 in an opposite second horizontal axial direction along longitudinal axis LA (e.g. to the left shown in FIG. 10). This draws operating cable 140 in the same second axial direction, and downwards via gravity by the weight of the feeder pan assembly 112 and feed stored in feeder tower 40 which presses downwards on feeder pan 30. The weight of feeder pan assembly 112 keeps operating cable 140 tensioned and tight at all times except if feeder pan 30 fully rests on the floor.

With feeder pan assembly 112 now in a fully open position, feed may flow freely into feeder pan 30 via gravity to feed the birds. Once the feeding cycle is completed, the feeder pan assembly 112 including now empty feeder pan 30 may be returned to the raised closed position shown in FIG. 10 and refilled by performing the same steps noted above via moving anti-roost wire 130 again in the first axial direction.

In one embodiment, the anti-roost wire 130 is moved axially in opposing directions to selectively open and close feeder pan assembly 112 in the foregoing steps by operation of winch 120 via rotating handle 124 clockwise or counter-clockwise, in the manner already described herein.

In the same manner previously described with respect to feeder 20 and FIGS. 5-7, it will be appreciated that the adjusting collar 60 may be similarly used and rotated to preselect the size of gap G formed between the feeder pan 30 and bottom end 49 of feeder tower 40 when the feeder pan assembly 112 is in the lowered open feeding position shown in FIG. 11. Since bottom end 64 of adjusting collar 60 preferably engages travel stop surface 48b defined on frusto-conical shaped transition section 48 of feeder tower 40 when feeder pan assembly 112 is in the closed position shown in FIG. 11, this determines the amount and level of feed entering the feeder pan 30 during a feeding cycle so as to ration the feed in a controlled manner to the birds.

All patents and published patent applications identified herein are incorporated herein by reference in their entireties.

While the foregoing description and drawings represent preferred or exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes and/or control logic as applicable described herein may be made without departing from the spirit of the invention. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A poultry feeder comprising:
a feeder pan assembly including a feeder pan, a grill assembly mounted on the feeder pan, and an adjusting collar supported by the grill assembly; and
a feeder tower including an upper portion for receiving feed and a lower portion having an open bottom end for dispensing feed into the feeder pan,
the feeder pan assembly being axially moveable as a unit relative to the feeder tower from an open position in which the feeder pan is disengaged from the feeder tower, to a closed position in which the feeder pan is engaged with the feeder tower;
wherein the feeder is operable to preclude feed from entering the feeder pan from the feeder tower when the feeder pan assembly is in the closed position and operable to dispense feed from the feeder tower into the feeder pan when the feeder pan assembly is in the open position.

2. The feeder of claim 1, wherein the bottom end of the feeder tower engages the feeder pan in the closed position and the bottom end of the feeder tower is spaced apart from the feeder pan by a gap in the open position.

3. The feeder of claim 2, wherein the feeder pan assembly is raised upwards with respect to the feeder tower when moving from the open position to the closed position.

4. The feeder of claim 3, further comprising an operating cable attached to the feeder pan assembly, the cable being coupled to a lifting mechanism operable to raise the feeder pan assembly from the open position to the closed position.

5. The feeder of claim 4, wherein the operating cable is connected to an anti-roost wire which is coupled to the lifting mechanism, the anti-roost wire being axially moveable via operating the lifting mechanism.

6. The feeder of claim 5, wherein moving the anti-roost wire in a first axial direction raises the feeder pan assembly and moving the anti-roost wire in a second opposite axial direction lowers the feeder pan assembly.

7. The feeder of claim 5, wherein the lifting mechanism is a winch.

8. The feeder of claim 7, wherein the winch and feeder tower are mounted on a feed conveyor tube that transports feed to the feeder tower.

9. The feeder of claim 1, wherein the adjusting collar engages the feeder tower when in the feeder pan assembly is in the open position.

10. The feeder of claim 9, wherein the adjusting collar engages an angled radial wall on a frusto-conical section of the feeder tower.

11. The feeder of claim 1, wherein the adjusting collar is rotatably supported by the grill assembly, the adjusting collar being selectively adjustable in vertical position with respect to the feeder pan and grill assembly by rotating the adjusting collar.

12. The feeder of claim 11, wherein the adjusting collar is operable to vary a gap in size formed between the bottom of the feeder tower and feeder pan when the feeder pan assembly is in the open position.

13. The feeder of claim 11, wherein the grill assembly includes a helically threaded hub encircling the feeder tower, the adjusting collar including mating helical threads for rotatably engaging the hub.

14. A poultry feeder comprising:
a feeder tower including an upper portion for receiving feed and a lower portion having an open bottom end for dispensing feed, the upper portion configured for mounting on a longitudinally-extending feed conveyor tube of a poultry feeding system containing feed;
an anti-roost wire supported by the feeder tower above the feed conveyor tube;
a feeder pan including a bowl portion for holding feed and a central portion extending upwardly from the bowl portion at least partially into the feeder tower;
a grill assembly mounted on the feeder pan, the grill assembly including a plurality of ribs and a cylindrical hub elevated above the feeder pan;
an adjusting collar concentrically arranged inside the hub, the collar rotatably engaging the hub and being vertically positionable with respect to the hub by rotating the collar,
the feeder pan, grill assembly, and adjusting collar collectively defining a feeder pan assembly, the feeder pan assembly being vertically moveable relative to the feeder tower from a lowered open position in which the bottom end of the feeder tower is spaced above the feeder pan by a distance, to a raised closed position in which the bottom of the feeder pan is engaged with the feeder tower;
the feeder being operable to preclude feed from entering the feeder pan from the feeder tower when the feeder pan assembly is in the closed position and operable to dispense feed from the feeder tower into the feeder pan when the feeder pan assembly is in the open position;
a winch coupled to the anti-roost wire and operable to move the anti-roost wire in opposing longitudinal directions; and
an operating cable attached to the feeder pan assembly, the cable being coupled to anti-roost wire and operable to raise the feeder pan assembly from the open position to the closed position via movement of the anti-roost wire by the lifting mechanism.

15. The feeder of claim 14, wherein the feed conveyor tube and feeder tower remain stationary while the feeder pan assembly is moved between the open and closed positions.

16. A method for operating a poultry feeder comprising:
providing a poultry feeder comprising a feeder pan, a grill assembly, an adjusting collar, and a feeder tower configured for receiving and dispensing feed to the feeder pan, wherein the feeder pan, grill assembly, and adjusting collar collectively define an interconnected feeder pan assembly being independently movable from the feeder tower;
positioning the feeder pan at an elevated position above the floor of a poultry house;
engaging an open bottom end of the feeder tower with the feeder pan, the feeder pan assembly being in a first raised closed position;
filling the feeder tower with feed, wherein feed is prevented from flowing into the feeder pan by the engagement between the bottom end of feeder tower and the pan;
lowering the feeder pan assembly to a second lowered open position; and
disengaging the bottom end of the feeder tower from the feeder pan to form a gap therebetween, wherein feed flows into the feeder pan from the feeder tower.

17. The method of claim 16, wherein the lowering step comprises lowering an operating cable attached to the feeder pan assembly in a first direction, wherein the feeder pan assembly moves downwards with respect to the feeder tower which remains in a stationary position.

18. The method of claim 17, wherein the operating cable is attached to an anti-roost wire, the anti-roost wire being moved in a first horizontal direction which causes the lowering of the operating cable to move the feeder pan assembly downwards.

19. The method of claim 17, further comprising a step of raising the operating cable in a second direction and simultaneously raising the feeder pan assembly back to the first raised closed position, wherein the bottom end of the feeder tower engages the feeder pan.

20. The method of claim 18, further comprising moving the anti-roost wire in a second horizontal direction opposite the first direction, and simultaneously raising the feeder pan assembly back to the first raised closed position.
